(19) United States
(12) Patent Application Publication
(10) Pub. No.: US 2013/0157860 A1
(43) Pub. Date: Jun. 20, 2013

(54) METHOD OF CONTROLLING A WEED IN A GRAMINEOUS BIOMASS CROP

(71) Applicant: SUMITOMO CHEMICAL COMPANY, LIMITED, Tokyo (JP)

(72) Inventor: Junko INABA, Takarazuka-shi (JP)

(73) Assignee: SUMITOMO CHEMICAL COMPANY, LIMITED, Tokyo (JP)

(21) Appl. No.: 13/711,879

(22) Filed: Dec. 12, 2012

(30) Foreign Application Priority Data
Dec. 15, 2011 (JP) 2011-274149

(51) Int. Cl. A01N 43/84; A01N 37/28; A01N 33/22; A01N 43/653; A01N 43/54

(52) U.S. Cl. CPC A01N 43/84; A01N 43/653; A01N 43/54; A01N 33/22; A01N 37/28
USPC 504/225; 504/273; 504/243; 504/352; 504/337

(57) ABSTRACT

A method of controlling a weed, which exhibits high herbicidal activity, without causing significant phytotoxicity on switchgrass, miscanthus, giant reed, reed canarygrass, blue stem, erianthus, napier grass or spartina. A method is provided of controlling a weed at a place where switchgrass, miscanthus, giant reed, reed canarygrass, blue stem, erianthus, napier grass or spartina grows, including applying an effective amount of a protoporphyrinogen oxidase inhibiting compound as an active ingredient to a place where switchgrass, miscanthus, giant reed, reed canarygrass, blue stem, erianthus, napier grass or spartina grows or will grow; and the method of controlling a weed at a place where switchgrass, miscanthus, giant reed, reed canarygrass, blue stem, erianthus, napier grass or spartina grows or will grow, wherein the protoporphyrinogen oxidase inhibiting compound is one or more compounds selected from the group consisting of flumioxazin, sulfentrazone, saflufenacil, oxyfluorfen, fomesafen and a compound represented by the following formula (I):

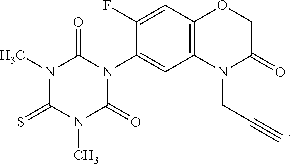 [SMILES: C#CCN1C(=O)COc2cc(F)c(-n3c(=O)n(C)c(=S)n(C)c3=O)cc21]

### BACKGROUND OF THE INVENTION

1. Field of the Invention

The present invention relates to a method of controlling a weed at a place where a gramineous biomass crop such as switchgrass, miscanthus, giant reed, reed canarygrass, blue stem, erianthus, napier grass or spartina grows.

2. Description of the Related Art

As a fuel used in a heat engine, fossil fuels has been mainly used. However fossil fuels are non-renewable recourses and the depletion of the reserves are concerned. In addition, carbon dioxide generated by burning of fossil fuels, and nitrogen oxide and sulfur oxide contained as impurities have become a factor of causing an environmental problem such as air pollution and global warming. For these reasons, as an energy source which is reproducible and hardly generates an environmental problem, ethanol and/or butanol produced from organisms, so called bioalcohol, including bioethanol, biomass ethanol, biobutanol, biomass butanol and so on, is expected.

As a raw material of the bioalcohol, from the viewpoint of the production efficiency, a plant containing sugar and starch at a large amount is selected, sugar cane, corn and sugar beet are cultivated. However, these are also a crop for foods or feeds, and as far as sugar cane, corn and sugar beet are used as a raw material of the bioalcohol, it results in that the bioalcohol and a food compete for the same plant.

On the other hand, as a raw material of the bioalcohol, study for using a perennial gramineous plant, called a biomass crop, such as switchgrass, miscanthus, giant reed, reed canarygrass, blue stem, erianthus, napier grass or spartina, which contains cellulose at a large amount, has progressed.

Currently, many herbicides are sold and used (see, for example, The Pesticide Manual Fourteenth Edition (2006), British Crop Protection Council (ISBN: 1-901396-14-2)), but a method of controlling a weed at a place where a biomass crop grows are limited. Moreover, a method of controlling a weed in a field of switchgrass, miscanthus, giant reed, reed canarygrass, blue stem, erianthus, napier grass or spartina grows, without causing significant phytotoxicity on switchgrass, miscanthus, giant reed, reed canarygrass, blue stem, erianthus, napier grass or spartina has not been disclosed.

### SUMMARY OF THE INVENTION

An object of the present invention is to provide an excellent weed controlling method which exhibits the high herbicidal activity, without causing significant phytotoxicity on a biomass crop.

The present invention provides a method of controlling a weed using a protoporphyrinogen oxidase inhibiting compound, without causing significant phytotoxicity on switchgrass, miscanthus, giant reed, reed canarygrass, blue stem, erianthus, napier grass or spartina. That is, the present invention provides:

(1) a method of controlling a weed at a place where switchgrass, miscanthus, giant reed, reed canarygrass, blue stem, erianthus, napier grass or spartina grows, comprising applying an effective amount of a protoporphyrinogen oxidase inhibiting compound selected from the group consisting of flumioxazin, sulfentrazone, saflufenacil, oxyfluorfen, fomesafen and a compound represented by the following formula (I):

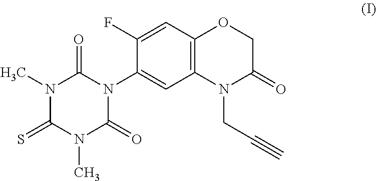 [SMILES: C#CCN1C(=O)COc2cc(F)c(-n3c(=O)n(C)c(=S)n(C)c3=O)cc21]

as an active ingredient to a field where switchgrass, miscanthus, giant reed, reed canarygrass, blue stem, erianthus, napier grass or spartina is cultivated or will be cultivated.
(2) The method according to (1), wherein the method of applying an effective amount of the protoporphyrinogen oxidase inhibiting compound is a pre-plant treatment method, a pre-emergence treatment method or a post-emergence treatment method.
(3) the method according to any one of (1) and (2), wherein the protoporphyrinogen oxidase inhibiting compound is flumioxazin.

According to the present invention, it becomes possible to provide an excellent weed controlling method, exhibiting the high herbicidal activity, which can be applied to a place where switchgrass, miscanthus, giant reed, reed canarygrass, blue stem, erianthus, napier grass or spartina grows.

In addition, according to the present invention, it becomes possible to increase the yield of cellulose from a plant of switchgrass, miscanthus, giant reed, reed canarygrass, blue stem, erianthus, napier grass or spartina.

### DETAILED DESCRIPTION OF THE PREFERRED EMBODIMENTS

Switchgrass in the present invention refers to Panicum virgatum. Miscanthus in the present invention refers to a Miscanthus gramineous plant such as Miscanthus giganteus, Miscanthus sinensis, and Miscanthus sacchariflorus. Giant reed refers to Arundo donax. Reed canarygrass in the present invention refers to Phalaris arundinacea. Blue stem in the present invention refers to Andropogon gerardii. Erianthus in the present invention refers to an Erianthus gramineous plant such as Erianthus ravennae and Erianthus arundinaceus. Napier grass in the present invention refers to Penninsetum purpureum. Spartina in the present invention refers to Spartina pectinata. These plants are gramineous perennial weeds, and contain cellulose which is to be a raw material of bioalcohol at a large amount.

Examples of the protoporphyrinogen oxidase inhibiting compound used as an active ingredient in the present invention include flumioxazin, sulfentrazone, saflufenacil, oxyfluorfen, fomesafen and a compound represented by the formula (I):

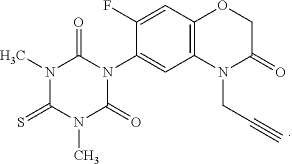 [SMILES: C#CCN1C(=O)COc2cc(F)c(-n3c(=O)n(C)c(=S)n(C)c3=O)cc21]

Fomesafen used in the method of the present invention may be a form of an acid, or may be a salt such as a fomesafen sodium salt (fomesafen-sodium).

Flumioxazin is a compound described in entry No. 388 of The Pesticide Manual Fourteenth Edition (2006), British Crop Protection Council (ISBN: 1-901396-14-2). Sulfentrazone is a compound described in entry No. 769 of The Pesticide Manual. Suflufenacil is a compound of CAS No. 372137-35-4. Oxyfluorfen is a compound described in entry No. 628 of The Pesticide Manual. Fomesafen is a compound of CAS No. 72178-02-0. A fomesafen sodium salt is a compound of CAS No. 108731-70-0. The compound represented by the formula (I) is a compound known by WO 02/066471.

The protoporphyrinogen oxidase inhibiting compound has the herbicidal activity on a wide range of weeds, and can effectively control a wide range of weeds in a field of switchgrass, miscanthus, giant reed, reed canarygrass, blue stem, erianthus, napier grass or spartina, and can increase a cellulose yield.

Examples of the weed which can be controlled by the protoporphyrinogen oxidase inhibiting compound include, but are not limited to, the followings:

Urticaceae weeds: Urtica urens

Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa

Portulacaceae weeds: Portulaca oleracea

Caryophyllaceae weeds: Stellaria media, Cerastium holosteoides, Cerastium glomeratum, Spergula arvensis, Silene gallica

Aizoaceae weeds: Mollugo verticillata

Chenopodiaceae weeds: Chenopodium album, Chenopodium ambrosioides, Kochia scoparia, Salsola kali, Atriplex spp.

Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella

Papaveraceae weeds: Papaver rhoeas, Argemone mexicana

Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rcrippa sylvestris, Thlaspi arvense, Myagrum rugosum, Lepidium virginicum, Coronopus didymus

Capparaceae weeds: Cleome affinis

Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis

Oxalidaceae weeds: Oxalis corniculata, Oxalis strica, Oxalis oxyptera

Geraniaceae weeds: Geranium carolinense, Erodium cicutarium

Euphorbiaceae weeds: Euphorbia helioscopia, Euphorbia maculata, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis

Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Sterculiaceae weeds: Waltheria indica

Violaceae weeds: Viola arvensis, Viola tricolor

Cucurbitaceae weeds: Sicyos angulatus, Echinocystis lobata, Momordica charantia

Lythraceae weeds: Lythrum salicaria

Apiaceae weeds: Hydrocotyle sibthorpioides

Sapindaceae weeds: Cardiospermum halicacabum

Primulaceae weeds: Anagallis arvensis

Asclepiadaceae weeds: Asclepias syriaca, Ampelamus albidus

Rubiaceae weeds: Galium aparine, Galium spurium var. echinospermon, Spermacoce latifolia, Richardia brasiliensis, Borreria alata

Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia

Boraginaceae weeds: Myosotis arvensis

Lamiaceae weeds: Lamium purpureum, Lamium amplexicaule, Leonotis nepetaefolia, Hyptis suaveolens, Hyptis lophanta, Leonurus sibiricus, Stachys arvensis

Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides

Scrophulariaceae weeds: Veronica hederaefolia, Veronica persica, Veronica arvensis

Plantaginaceae weeds: Plantago asiatica

Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotcrum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis

Liliaceae weeds: Allium canadense, Allium vineale

Commelinaceae weeds: Commelina communis, Commelina bengharensis, Commelina erecta

Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis

Cyperaceae weeds: Cyperus microiria, Cyperus iria, Cyperus odoratus, Cyperus rotundus, Cyperus esculentus, Kyllinga gracillima

Equisetaceae weeds: Equisetum arvense, Equisetum palustre etc.

Switchgrass, miscanthus, giant reed, reed canarygrass, blue stem, erianthus, napier grass or spartina herein includes switchgrass, miscanthus, giant reed, reed canarygrass, blue stem, erianthus, napier grass or spartina to which resistance to a HPPD inhibiting compound such as isoxaflutole; an ALS inhibiting compound such as imazethapyr or thifensulfuron methyl; an EPSP synthase inhibiting compound such as glyphosate; a glutamine synthase inhibiting compound such as glufosinate; an acetyl CoA carboxylase inhibiting compound such as sethoxydim; a PPO inhibiting compound such as flumioxazin; or a herbicide such as bromolynil, dicamba or 2,4-D has been imparted by a classical breeding method or a genetic engineering technique.

Switchgrass, miscanthus, giant reed, reed canarygrass, blue stem, erianthus, napier grass or spartina herein includes switchgrass, miscanthus, giant reed, reed canarygrass, blue stem, erianthus, napier grass or spartina, which has become possible to synthesize a selective toxin known in Bacillus genus, using a genetic engineering technique.

Examples of the toxin which is expressed in such a genetically engineered switchgrass, miscanthus, giant reed, reed canarygrass, blue stem, erianthus, napier grass or spartina include an insecticidal protein derived from Bacillus cereus or Bacillus popilliae; a δ-endotoxin such as Cry1Ab, Cry1Ac, Cry1F, Cry1Fa2, Cry2Ab, Cry3A, Cry3Bb1 or Cry9C, derived from Bacillus thuringiensis; an insecticidal protein such as VIP1, VIP2, VIP3 or VIP3A; an insecticidal protein derived from nematode; a toxin produced by an animal such as a scorpion toxin, a spider toxin, a bee toxin or an insect-specific neurotoxin; a filamentous fungus toxin; plant lectin; agglutinin; a protease inhibitor such as a trypsin inhibitor, a serine protease inhibitor, patatin, cystatin, and a papain inhibitor; a ribosome inactivating protein (RIP) such as lysine, corn-RIP, abrin, luffin, saporin or bryodin; a steroid metabolism enzyme such as 3-hydroxysteroid oxidase, ecdysteroid-UDP-glycosyltransferase, and cholesterol oxidase; an ecdysone inhibitor; HMG-CoA reductase; an ion channel inhibitor such as a sodium channel inhibitor or a calcium channel inhibitor; juvenile hormone esterase; a diuretic hormone receptor; stilbene synthase; bibenzyl synthase; chitinase; glucanase; and the like.

A toxin expressed by the genetically engineered switchgrass, miscanthus, giant reed, reed canarygrass, blue stem, erianthus, napier grass or spartina includes a hybrid toxin of a δ-endotoxin protein such as Cry1Ab, Cry1Ac, Cry1F, Cry1Fa2, Cry2Ab, Cry3A, Cry3Bb1 or Cry9C, and an insecticidal protein such as VIP1, VIP2, VIP3 or VIP3A, and a partially deleted toxin, and a modified toxin. The hybrid toxin can be produced by a new combination of different domains of these proteins using a genetic engineering technique. As the partially deleted toxin, Cry1Ab in which a part of an amino acid sequence has been deleted is known. In the modified toxin, one or a plurality of amino acids of a natural toxin are substituted.

These toxins are described in EP-A-0374753, WO 93/07278, WO 95/34656, EP-A-0427529, EP-A-451878, and WO 03/052073 and the like.

These toxins impart resistance to Coleoptera vermin, Diptera vermin and Lepidoptera vermin to switchgrass, miscanthus, giant reed, reed canarygrass, blue stem, erianthus, napier grass or spartina.

Switchgrass, miscanthus, giant reed, reed canarygrass, blue stem, erianthus, napier grass or spartina herein also includes switchgrass, miscanthus, giant reed, reed canarygrass, blue stem, erianthus, napier grass or spartina to which the ability to produce an anti-pathogenic substance having selective action has been imparted using a genetic engineering technique.

Examples of the anti-pathogenic substance include a PR protein (PRPs, described in EP-A-039225); an ion channel inhibitor such as a sodium channel inhibitor or a calcium channel inhibitor (KP1, KP4 and KP6 toxins, etc., which are produced by viruses, have been known); stilbene synthase; bibenzyl synthase; chitinase; glucanase; substances produced by microorganisms such as a peptide antibiotic, an antibiotic having a heterocycle, and a protein factor involved in plant disease resistance. The anti-pathogenic substances are described in EP-A-0392225, WO 95/33818, and EP-A-0353191.

Switchgrass, miscanthus, giant reed, reed canarygrass, blue stem, erianthus, napier grass or spartina herein includes switchgrass, miscanthus, giant reed, reed canarygrass, blue stem, erianthus, napier grass or spartina to which a useful character such as a cellulose content increasing character has been imparted by recombinant DNA technique.

Further, switchgrass, miscanthus, giant reed, reed canarygrass, blue stem, erianthus, napier grass or spartina herein includes stack varieties in which a plurality of the classical herbicide characters or useful characters such as a herbicide-resistant gene, an insecticidal vermin-resistant gene, and an anti-pathogenic substance production gene are combined.

In the method of controlling a weed of the present invention, one or more other agrochemicals can be also used together in addition to the protoporphyrinogen oxidase inhibiting compound which is applied as an active ingredient. Examples of the other agrochemicals include an insecticidal agent, a miticide, a nematicide, a fungicide, a herbicide, a plant growth regulating agent and a safener.

Among the other agrochemicals, examples of the herbicide include the followings:

Dicamba and a salt thereof (diglycolamine salt, dimethylammonium salt, isopropylammonium salt, potassium salt, sodium salt, choline salt), 2,4-D and a salt or ester thereof (butotyl ester, dimethylammonium salt, diolamine salt, ethylhexyl ester, isooctyl ester, isopropylammonium salt, sodium salt, triisopropanolamine salt, choline salt), 2,4-DB and a salt or ester thereof (dimethylammonium salt, isooctyl ester, choline salt), MCPA and a salt or ester thereof (dimethylammonium salt, 2-ethylhexyl ester, isooctyl ester, sodium salt, choline salt), MCPB, mecoprop and a salt or ester thereof dimethylammonium salt, diolamine salt, ethadyl ester, 2-ethylhexyl ester, isooctyl ester, methyl ester, potassium salt, sodium salt, trolamine salt, choline salt), mecoprop-P and a salt or ester thereof (dimethylammonium salt, 2-ethylhexyl ester, isobutyl salt, potassium salt, choline salt), dichlorprop and a salt or ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, bromoxynil, bromoxynil-octanoate, dichlobenil, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminccyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, benzobicyclon, dithiopyr, triclopyr and a salt or ester thereof (butotyl ester, triethylammonium salt), fluoroxypyr, fluoroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, cicdinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glyphosate, glyphosate-isopropylamine, glyphosate-trimethylsulfonium, glyphosate-ammonium, glyphosate-diammonium, glyphosate-sodium, glyphosate-potassium, glyphosate-guanidine, glufosinate, glufosinate-ammonium, glufosinate-P, glufosinate-P-sodium, bialafos, anilofos, bensulide, butamifos, paraquat, paraquat-dichloride, diquat, diquat-dibromide, and agrochemically acceptable salts thereof.

The protoporphyrinogen oxidase inhibiting compound and/or other agrochemicals applied as an active ingredient in the present method are used by formulating into a preparation in a dosage form advantageous for use purpose, by dissolving or dispersing them in a suitable liquid carrier or mixing them with a suitable solid carrier, or adsorbing them onto a suitable solid carrier. A preparation of the present inhibitor is in a form of, for example, an emulsifiable concentrate, a liquid formulation, an oil solution, a spray, a wettable powder, a dust formulation, a DL (Drift Less)-type dust formulation, a granule, a fine granule, a F fine granule, a F small granule F, a water dispersible granule, a water soluble powder, a flowable, a dry flowable, a Jumbo formulation, a tablet, or a paste. These preparations can be prepared by the known method by further adding, as necessary, formulation auxiliaries such as emulsifiers, dispersant, spreaders, penetrants, wetting agents, binders, thickeners, antiseptics, antioxidants and colorants.

Examples of the liquid carrier used upon formulation into a preparation include water, alcohols (e.g. methanol, ethanol, 1-propanol, 2-propanol, ethylene glycol etc.), ketones (e.g. acetone, methyl ethyl ketone etc.), ethers (e.g. dioxane, tetrahydrofuran, ethylene glycol monomethyl ether, diethyl glycol monomethyl ether, propylene glycol monomethyl ether etc.), aliphatic hydrocarbons (e.g. hexane, octane, cyclohexane, kerosene, fuel oil, machine oil etc.), aromatic hydrocarbons (e.g. benzene, toluene, xylene, solvent naphtha, methyl naphthalene etc.), halogenated hydrocarbons (e.g. dichloromethane, chloroform, carbon tetrachloride etc.), acid amides (e.g. dimethylformamide, dimethylacetamide, N-methylpyrrolidone etc.), esters (e.g. ethyl acetate, butyl acetate, fatty acid glycerin ester etc.), and nitriles (e.g. acetonitrile, propionitrile etc.). These liquid carriers can be also used by mixing two or more kinds at an appropriate ratio.

Examples of the solid carrier used upon formulation into a preparation include plant flours (e.g. soybean flour, tobacco flour, wheat flour, wood flour etc.), mineral powders (e.g. clays such as kaolin, bentonite, acid clay, and clay, talcs such as talcum powder and pyrophyllite powder, silicas such as diatomaceous earth, and mica powder), alumina, sulfur powder, active carbon, saccharides (e.g. lactose, glucose etc.), inorganic salts (e.g. calcium carbonate, sodium bicarbonate etc.), and glass hollow bodies (obtained by firing natural vitreous, allowing bubbles to be contained therein). These solid carriers can be also used by mixing two or more kinds at an appropriate ratio.

The liquid carrier or the solid carrier is used at a proportion of usually 1 to 99% by weight, preferably about 10 to 99% by weight.

As the emulsifier, dispersant, spreader, penetrant and wetting agent, a surfactant is usually used. Examples of the surfactant include anionic surfactants such as alkylsulfuric acid ester salts, alkylarylsulfonic acid salts, dialkylsulfosuccinic acid salts, polyoxyethylene alkyl aryl ether phosphoric acid ester salts, ligninsulfonic acid salts, and naphthalenesulfonate formaldehyde polycondensate, and nonionic surfactants such as polyoxyethylene alkyl ether, polyoxyethylene alkyl aryl ether, polyoxyethylene alkyl polyoxypropylene block copolymer, and sorbitan fatty acid ester. Two or more kinds of these surfactants can be also used. The surfactant is used at a proportion of usually 0.1 to 50% by weight, preferably about 0.1 to 25% by weight based on a whole preparation.

Examples of the binder and the thickener include dextrin, a sodium salt of carboxymethylcellulose, polycarboxylic acid-based polymer compound, polyvinylpyrrolidone, polyvinyl alcohol, sodium ligninsulfonate, calcium ligninsulfonate, poly(sodium acrylate), gum arabic, sodium alginate, mannitol, sorbitol, bentonite mineral matter, polyacrylic acid and a derivative thereof, a sodium salt of carboxymethylcellulose, white carbon, and a natural saccharide derivative (e.g. xanthan gum, guar gum etc.).

The total amount of active ingredients contained in a preparation is usually a proportion of 1 to 90% by weight based on a total preparation in the case of an emulsifiable concentrate, a wettable powder, a water dispersible granule, a liquid formulation, a water soluble powder, or a flowable, usually a proportion of 0.01 to 10% by weight based on a total preparation in the case of an oil solution, a dust formulation, or a DL-type dust formulation, and usually a proportion of 0.05 to 10% by weight based on a total preparation in the case of a fine granule, a F fine granule, a F small granule, or a granule, and these concentrations may be appropriately changed depending on use purpose. An emulsifiable concentrate, a wettable powder, a water dispersible powder, a liquid formulation, a water soluble powder, or a flowable is usually used by appropriately diluting with water, and is usually used by diluting about 100 to 100,000-fold.

In the method of the present invention, when a solution obtained by diluting a preparation with water or the like is sprayed, an adjuvant may be added to the spraying liquid. Examples of the adjuvant which can be added include surfactants (nonionic surfactants such as fatty acid alkyl ester, and alkyl polyoxyethylene ether, ionic surfactants such as alkylbenzenesulfonic acid salt, and dialkyldimethylammonium salt), crop oils, vegetative oils, crop oil concentrates, methylated seed oils, organosilicon-based spreaders, and liquid fertilizers (ammonium sulfate, urea ammonium nitrate etc.). These adjuvants may be used alone or may be used by combining two or more kinds.

As the method of the present invention, a method similar to the conventional known agrochemical application method can be used as far as it is a treatment method applicable to switchgrass, miscanthus, giant reed, reed canarygrass, blue stem, erianthus, napier grass or spartina, and examples include pre-plant treatment, pre-emergence treatment and post-emergence treatment. The pre-plant treatment is to apply an active ingredient to a soil or a weed before seeding of switchgrass, miscanthus, giant reed, reed canarygrass, blue stem, erianthus, napier grass or spartina, or before transplantation of a seedling of switchgrass, miscanthus, giant reed, reed canarygrass, blue stem, erianthus, napier grass or spartina. The pre-plant treatment includes the pre-plant incorporation. The pre-plant incorporation is to scatter an active ingredient on a soil and incorporate the active ingredient into a soil before seeding of switchgrass, miscanthus, giant reed, reed canarygrass, blue stem, erianthus, napier grass or spartina, or before transplantation of a seedling of switchgrass, miscanthus, giant reed, reed canarygrass, blue stem, erianthus, napier grass or spartina. The pre-emergence treatment is to scatter an active ingredient on a soil before germination of switchgrass, miscanthus, giant reed, reed canarygrass, blue stem, erianthus, napier grass or spartina. The post-emergence treatment means that an active ingredient is applied to a soil or a weed after germination of switchgrass, miscanthus, giant reed, reed canarygrass, blue stem, erianthus, napier grass or spartina, and includes inter-ridge treatment. The post-emergence treatment may be before germination or after germination of a weed. The inter-ridge treatment is a method of treating the vicinity of switchgrass, miscanthus, giant reed, reed canarygrass, blue stem, erianthus, napier grass or spartina with an active ingredient (spraying or irrigating an active ingredient to the vicinity of switchgrass, miscanthus, giant reed, reed canarygrass, blue stem, erianthus, napier grass or spartina), after germination of switchgrass, miscanthus, giant reed, reed canarygrass, blue stem, erianthus, napier grass or spartina. The inter-ridge treatment is classified into inter-ridge treatment•weed pre-emergence treatment and inter-ridge treatment•weed post-emergence treatment, depending on before germination and after germination of a weed, in some cases.

The use amount of an active ingredient in the present invention can be appropriately changed, depending on an application region, an application term, an application method, and a subject grass species and, usually, the total amount of active ingredients is around 1 to 20000 g, preferably around 10 to 5000 g per 1 hectare of a field of switchgrass, miscanthus, giant reed, reed canarygrass, blue stem, erianthus, napier grass or spartina.

### EXAMPLES

The present invention will be described in more detail by way of examples, but the present invention is not limited to these examples.

Test Examples are shown below.

### Test Example 1

Pre-emergence application in switchgrass, miscanthus, giant reed, reed canarygrass, blue stem, erianthus, napier grass and spartina

A field soil is filled into a 32 cm×22 cm plastic case having a depth of 8 cm, seeds of switchgrass, miscanthus, giant reed, reed canarygrass, blue stem, erianthus, napier grass, spartina, Setaria faberi, Amaranthus retroflexus, Chenepodium album, and Stellaria media are seeded thereon, and the seeds are covered with about 0.5 cm of a soil. Then, a diluted solution of flumioxazin, sulfentrazone, saflufenacil, oxyfluorfen, fomesafen or a compound represented by the formula (I) is uniformly applied to the soil surface so that the amount of flumioxazin, sulfentrazone, saflufenacil, oxyfluorfen, fomesafen or a compound represented by the formula (I) became 25 to 1000 g per 1 hectare. The plant after the application is cultivated in a greenhouse, and when phytotoxicity and the herbicidal activity are evaluated 21 days after treatment, the high herbicidal activity is exhibited, without causing significant phytotoxicity on switchgrass, miscanthus, giant reed, reed canarygrass, blue stem, erianthus, napier grass, and spartina.

### Test Example 2

Post-emergence application in Switchgrass, miscanthus, giant reed, reed canarygrass, blue stem, erianthus, napier grass and spartina

A field soil is filled into a 32 cm×22 cm plastic case having a depth of 8 cm, seeds of switchgrass, miscanthus, giant reed, reed canarygrass, blue stem, erianthus, napier grass, spartina, Echinochloa crus-galli, Digitaria adscendens, Chenopodium album and Abutilon theophrasti are seeded thereon, and the seeds are covered with about 0.5 cm of a soil, and cultivated in a greenhouse for 2 weeks. Then, a diluted solution of flumioxazin, sulfentrazone, saflufenacil, oxyfluorfen, fomesafen or a compound represented by the formula (I) is uniformly applied to the soil surface so that the amount of flumioxazin, sulfentrazone, saflufenacil, oxyfluorfen, fomesafen or a compound represented by the formula (I) became 25 to 1000 g per 1 hectare. The plant after the application is cultivated in a greenhouse and, when phytotoxicity and the herbicidal activity are evaluated 21 days after treatment, the high herbicidal activity is exhibited, without causing a significant phytotoxicity on switchgrass, miscanthus, giant reed, reed canarygrass, blue stem, erianthus, napier grass, and spartina.

According to the present invention, a weed at a place where switchgrass, miscanthus, giant reed, reed canarygrass, blue stem, erianthus, napier grass, or soartina grows can be controlled without causing significant phytotoxicity on a biomass crop above. In addition, according to present invention, the increasing of yield of cellulose from a biomass crop above can be expected.

What is claimed is:

1. A method of controlling a weed at a place where switchgrass, miscanthus, giant reed, reed canarygrass, blue stem, erianthus, napier grass or spartina grows, comprising applying an effective amount of a protoporphyrinogen oxidase inhibiting compound selected from the group consisting of flumioxazin, sulfentrazone, saflufenacil, oxyfluorfen, fomesafen and a compound represented by the following formula (I): 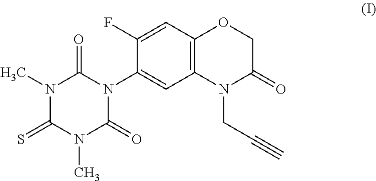 [SMILES: C#CCN1C(=O)COc2cc(F)c(-n3c(=O)n(C)c(=S)n(C)c3=O)cc21]
as an active ingredient to a field where switchgrass, miscanthus, giant reed, reed canarygrass, blue stem, erianthus, napier grass or spartina is cultivated or will be cultivated.

2. The method according to any one of claims 1, wherein the method of applying an effective amount of the protoporphyrinogen oxidase inhibiting compound is a pre-plant treatment method, a pre-emergence treatment method or a post-emergence treatment method.

3. The method according to any one of claim 1 and claim 2, wherein the protoporphyrinogen oxidase inhibiting compound is flumioxazin.
